(19) United States
(12) Patent Application Publication
(10) Pub. No.: US 2017/0121657 A1
(43) Pub. Date: May 4, 2017

(54) BEER-TASTE BEVERAGE, METHOD FOR PRODUCING THE SAME, AND METHOD FOR IMPROVING TASTE OF THE SAME

(71) Applicant: Sapporo Holdings Limited, Tokyo (JP)

(72) Inventor: Yoichi KOZAKI, Tokyo (JP)

(73) Assignee: Sapporo Holdings Limited, Tokyo (JP)

(21) Appl. No.: 15/336,375

(22) Filed: Oct. 27, 2016

(30) Foreign Application Priority Data
Oct. 30, 2015 (JP) 2015-214849

(51) Int. Cl. C12C 11/11; C12C 12/00

(52) U.S. Cl. CPC C12C 11/11; C12C 12/00

(57) ABSTRACT

Objects of the present invention are to provide a beer-taste beverage excellent in “umami (taste)”, refreshing feeling and “kire (sharpness)”, a method for producing the same, and a method for improving taste of the same. In the beer-taste beverage according to the present invention, use ratio of malt is at least 50%, alcohol content is at least 4%, bitterness value is at least 10, and total polyphenol is 140 ppm or less. The method for producing the beer-taste beverage includes a fermentation step of obtaining fermentation liquid by alcohol fermentation, and a post-fermentation step after alcohol fermentation, wherein in the post-fermentation step, fermentation liquid obtained in the fermentation step is treated with polyvinylpolypyrrolidone, to reduce the total polyphenol to 140 ppm or less.

### TECHNICAL FIELD

The present invention relates to a beer-taste beverage, a method for producing the same, and a method for improving taste of the same.

### BACKGROUND ART

In order to satisfy a variety of preferences of drinkers, many types of beer-taste beverages and methods for producing the same have been proposed. For example, in Patent Document 1, in order to meet demand for low-alcohol beverage, there is proposed a method for producing an alcoholic beverage, wherein an alcohol-containing stock solution is separated into permeate and concentrate of the stock solution by a reverse osmosis membrane, and they are blended to obtain the alcoholic beverage. Patent Document 1 describes a light beer (1) and a light beer (2) as examples of the alcoholic beverages obtained by this production method.

The light beer (1) and the light beer (2) described in Patent Document 1 are respectively obtained by blending permeate and concentrate obtained by separation with the reverse osmosis membrane at a predetermined ratio. Therefore, Patent Document 1 describes that both of the light beers have refreshing feeling, since extract content is about ⅔ of the stock solution, and amino acid and fermentable sugar are also ⅔ of the stock solution in accordance with reduction of the extract content. Further, Patent Document 1 describes that both of the light beers have mild characteristics, since isohumulone and polyphenols, which are bitter components, are reduced to about ½ of the stock solution.

### CITATION LIST

### Patent Literature

[Patent Document 1]

Japanese Patent Application Publication No. H04-287677

### SUMMARY OF INVENTION

### Technical Problem

As described above, the alcoholic beverages (for example, the light beer (1) and the light beer (2)) described in Patent Document 1 have refreshing feeling and mild characteristics, however, there is a possibility that “umami (taste)” is impaired in accordance with reduction of the extract content. Further, in general, there has been a strong demand that the beer-taste beverage is excellent in refreshing feeling and “kire (sharpness)” as preferences of beer-taste beverage drinkers. Here, “umami” in the present specification means good taste of the beverage having good body and taste. “Refreshing feeling” means feeling such as refreshing and invigorating feeling when drinking typical draft beer. “Kire (sharpness)” means sharpness of taste disappearance after feeling “umami”.

The present invention has been made in view of the above circumstances, and objects of the present invention are to provide a beer-taste beverage excellent in “umami”, refreshing feeling and “kire”, a method for producing the same, and a method for improving taste of the same.

### Solution to Problem

The above problems can be solved by the following means.
(1) A beer-taste beverage, wherein use ratio of malt is at least 50%, alcohol content is at least 4%, bitterness value is at least 10, and total polyphenol is 140 ppm or less.
(2) The beer-taste beverage described in the above (1), wherein the malt is barley malt.
(3) The beer-taste beverage described in the above (2), wherein the barley malt contains LOX-less malt.
(4) The beer-taste beverage described in any one of the above (1) to (3), wherein total nitrogen is at least 40 mg/100 mL.
(5) The beer-taste beverage according to any one of the above (1) to (4), wherein original wort extract concentration is at least 10%.
(6) The beer-taste beverage according to any one of the above (1) to (5), containing hop extract as a bittering agent, wherein a use ratio of the hop extract to the bittering agent is 15% to 100%.
(7) The beer-taste beverage according to any one of the above (1) to (6), wherein gas pressure is at least 1.8 kg/cm².
(8) A method for producing a beer-taste beverage, in which use ratio of malt is at least 50%, alcohol content is at least 4%, bitterness value is at least 10, and total polyphenol is 140 ppm or less, the method comprising: a fermentation step of obtaining fermentation liquid by alcohol fermentation; and a post-fermentation step after alcohol fermentation, wherein in the post-fermentation step, fermentation liquid obtained in the fermentation step is treated with polyvinylpolypyrrolidone, to reduce the total polyphenol to 140 ppm or less.
(9) The method for producing the beer-taste beverage described in the above (8), wherein heat treatment is not performed in the post-fermentation step.
(10) A method for improving taste of a beer-taste beverage, wherein the taste of the beer-taste beverage is improved so that use ratio of malt is at least 50%, alcohol content is at least 4%, bitterness value is at least 10, and total polyphenol is 140 ppm or less.

### Advantageous Effects of Invention

The beer-taste beverage according to the present invention is excellent in “umami”, refreshing feeling and “kire”.

By the method for producing the beer-taste beverage according to the present invention, it is possible to produce the beer-taste beverage excellent in “umami”, refreshing feeling and “kire”.

By the method for improving taste of the beer-taste beverage according to the present invention, it is possible to improve “umami”, refreshing feeling and “kire” of the beer-taste beverage.

### BRIEF DESCRIPTION OF DRAWINGS

FIG. 1 is a flowchart illustrating a method for producing a beer-taste beverage according to an embodiment of the present invention.

### DESCRIPTION OF EMBODIMENTS

Hereinafter, embodiments of a beer-taste beverage according to the present invention, a method for producing the same, and a method for improving taste of the same will be described.

### [Beer-Taste Beverage]

In the beer-taste beverage according to the present invention, use ratio of malt is at least 50%, alcohol content is at least 4%, bitterness value is at least 10, and total polyphenol is 140 ppm or less. Here, the beer-taste beverage means a beverage having a beer-like taste, that is, a beverage giving drinkers a feeling as if drinking beer. The beer-taste beverage of the present invention includes, for example, beer, low-malt beer and liqueur.

### (Use Ratio of Malt)

The malt refers to barley, wheat, rye, oat or the like, which are germinated under predetermined conditions. The malt can be used in a state of being germinated or being crushed in appropriate sizes. Note that, the malt has a great influence on flavor and taste (for example, “umami”) of the beer-taste beverage, and is nitrogen source and carbon source assimilable by yeast in a case of alcohol fermentation. In the present invention, it is preferable to use barley malt in view of obtaining flavor, taste or the like suitable as the beer-taste beverage.

The barley malt preferably contains LOX-less malt. The LOX-less malt is malt obtained by malting barley (LOX-less barley) which does not contain enzyme lipoxygenase-1 (LOX-1) that oxidizes lipid. By containing the LOX-less malt, it is possible to improve flavor stability, thereby maintaining flavor quality having excellent “umami”, refreshing feeling and “kire” even in long-term storage products. The above-described effects are easily obtained as a use ratio of the LOX-less malt to the barley malt is higher. Therefore, in view of obtaining the above-described effects, it is preferred that the use ratio of the LOX-less malt to the barley malt is 100% (wt %), however, it can be set to 0 to 100% in view of costs, preferences of the drinkers, and the like.

Further, in the present invention, use ratio of malt is at least 50% (wt %). Here, the use ratio of malt refers to use ratio of malt to raw materials excluding bittering agent (for example, hop) and water. In the present invention, by setting the use ratio of malt to at least 50%, it is possible to obtain the flavor and taste suitable for the beer-taste beverage. Note that, the use ratio of malt is preferably at least 66.7% in view of obtaining more preferable flavor, taste and the like as the beer-taste beverage. The use ratio of malt can be 100%.

As materials other than the malt, which are the nitrogen source and carbon source assimilable by yeast, it is possible to use, for example, ungerminated barley, wheat, rye, oat, pea, corn, rice or soybean, but it is also possible to use raw materials other than these. Note that, since these raw materials also have an influence on the flavor and taste of the beer-taste beverage, it is preferable to appropriately select them to meet the preferences of the drinkers.

### (Alcohol Content)

The alcohol content of the beer-taste beverage according to the present invention is at least 4% (also referred to as vol/vol %, v/v % or the like). Alcohol contained in the beer-taste beverage is not limited to alcohol obtained by fermenting the raw materials such as the malt, but it is possible to add drinking alcohol if necessary in order to adjust the alcohol content or to meet the preferences of the drinkers. There is no limitation to type, production method, raw materials or the like of the drinking alcohol to be added. For example, one or a combination of raw material alcohol and various spirits such as “shochu (distilled spirit)”, brandy or vodka can be added. Note that, the spirits in the present specification refers to distilled spirits, and may be different from spirits in liquor tax law. When the alcohol content obtained by fermenting the raw materials is high, it may be diluted with water, carbon dioxide-containing water, or the like so as to have desired alcohol content. In view of easiness of drinking or the preferences of the drinkers, the alcohol content of the beer-taste beverage is preferably at least 5%. From the same point of view, the alcohol content of the beer-taste beverage is preferably at most 8%, and is more preferably at most 7%. The alcohol content of the beer-taste beverage according to the present invention can be measured according to, for example, the Alcolyzer method or a method described in section 8.3 Alcohol of Revised BCOJ beer analysis method (issued by Public Interest Incorporated Foundation Brewing Society of Japan, Brewers Association International Technology Committee [Analysis Committee] enlarged and revised edition, 2013).

### (Bitterness Value)

The bitterness value (also referred to as BU, IBU, bitterness unit or the like) of the beer-taste beverage according to the present invention is at least 10. In this way, it is possible to impart moderate bitterness to the beer-taste beverage according to the present invention. Therefore, the beer-taste beverage can have a beer-like taste (that is, it is possible to give the drinkers a feeling as if drinking beer). In view of imparting more suitable bitterness to the beer-taste beverage, the bitterness value is preferably at least 15, more preferably at least 20, and is preferably at most 50.

Incidentally, the bitterness value is used as a unit indicating bitterness of beer. The bitterness value of the beer-taste beverage according to the present invention can be understood in the same way as this. The bitterness value of the beer-taste beverage according to the present invention can be measured by, for example, a method described in section 8.15 Bitterness value of Revised BCOJ beer analysis method (issued by Public Interest Incorporated Foundation Brewing Society of Japan, Brewers Association International Technology Committee [Analysis Committee] enlarged and revised edition, 2013).

In the beer-taste beverage according to the present invention, the bitterness value of a final product only has to be at least 10 as described above, and its origin does not matter. The bitterness value of the beer-taste beverage can be adjusted to at least the above predetermined value by the bittering agent that is added during production. As the bittering agent, for example, hop, hop-processed product or the like can be used.

As the hop, for example, raw hop, hop pellets which are obtained by a pre-grinding process, hop pellets which are obtained by screening lupulin grains in advance during the process and contain a lot of lupulin, and hop extract which is obtained by extracting, for example, essential oil or bitter substance of the lupulin, can be used. Note that, as a method of adding the hop, there are kettle hopping, late hopping and dry hopping, however, it is not limited thereto. Here, the kettle hopping refers to adding the hop during rise in temperature of pre-fermentation liquid (wort) or early in the boiling of the wort, and the late hopping refers to adding the hop just before the end of the boiling of the wort. Further, the dry hopping refers to adding the hop after the beginning of the fermentation step.

Further, as the hop-processed product, for example, low hop, hexa-hop, tetra-hop or iso-hop extract can be used. The hop-processed product can be added in any one or more steps of pre-fermentation step S1 to post-fermentation step S3, which will be described below.

Note that, in the present invention, the beer-taste beverage preferably contains the hop extract among the above-described bittering agents. In this way, it is possible to reliably improve “kire” and refreshing feeling of the beer-taste beverage. Further, in this case, a use ratio of the hop extract to the bittering agent is preferably 15 to 100%. In this way, it is possible to further reliably improve “kire” and refreshing feeling of the beer-taste beverage. In view of further improving “kire” and refreshing feeling of the beer-taste beverage, the use ratio of the hop extract to the hop is more preferably 50 to 100%.

### (Total Polyphenol)

Polyphenol refers to a compound in which two or more hydrogens of an aromatic hydrocarbon are substituted with hydroxyl groups. As polyphenols, there are, for example, flavonol, isoflavone, tannin, catechin, quercetin and anthocyanin. The total polyphenol refers to a total amount of these polyphenols contained in the beer-taste beverage.

The total polyphenol is related to “umami”, refreshing feeling and “kire” of the beer-taste beverage according to the present invention. In the present invention, by reducing the total polyphenol to 140 ppm (mass ppm) or less, refreshing feeling and “kire” is improved without impairing “umami”. In view of improving refreshing feeling and “kire” without impairing “umami”, the total polyphenol is preferably at most 130 ppm, more preferably at most 120 ppm, further preferably at most 110 ppm, and further more preferably at most 100 ppm. Note that, the total polyphenol is preferably at least 50 ppm from the viewpoint of flavor stability.

As a method of reducing the total polyphenol to 140 ppm or less, there is a polyvinylpolypyrrolidone (PVPP) treatment applied to fermentation liquid obtained by alcohol fermentation in the post-fermentation step as described below. The total polyphenol of the beer-taste beverage according to the present invention can be measured by, for example, a method described in section 8.19 Total polyphenol of Revised BCOJ beer analysis method (issued by Public Interest Incorporated Foundation Brewing Society of Japan, Brewers Association International Technology Committee [Analysis Committee] enlarged and revised edition, 2013).

### (Total Nitrogen)

Total nitrogen (content of total nitrogen compound, that is, content of protein and amino acid) affects the taste such as “umami” of the beer-taste beverage. By increasing the total nitrogen to at least 40 mg/100 mL, it is possible to more reliably improve “umami”. In view of further improving “umami”, the total nitrogen is preferably at least 45 mg/100 mL and more preferably at least 50 mg/100 mL. Further, in view of balance of the taste, the total nitrogen is preferably at most 100 mg/100 mL. Note that, the total nitrogen depends on the use ratio of malt. Therefore, in order to increase the total nitrogen, it is preferable to increase the use ratio of malt. The total nitrogen of the beer-taste beverage according to the present invention can be measured by, for example, a method described in section 8.9 Total nitrogen of Revised BCOJ beer analysis method (issued by Public Interest Incorporated Foundation Brewing Society of Japan, Brewers Association International Technology Committee [Analysis Committee] enlarged and revised edition, 2013).

### (Original Wort Extract Concentration)

Original wort extract concentration refers to content of sugar contained in the beer-taste beverage, and affects the taste such as “umami” of the beer-taste beverage. In the present invention, the original wort extract concentration is preferably at least 10% (v/v %). In this way, it is possible to more reliably improve “umami”. In view of further improving “umami”, the original wort extract concentration is preferably at least 10.5% and more preferably 11%. Further in view of balance of flavor, the original wort extract concentration is preferably at most 15%. The original wort extract concentration can be adjusted, for example, by changing a ratio (mixing ratio) of mashing water to the malt and the like as the raw materials in a pre-fermentation step S1 described below, by evaporating water for concentration by boiling, by changing an amount of warm water which is added for adjusting extract content after boiling, and by using liquid sugar or malt extract. The original wort extract concentration can be measured by, for example, a method described in section 8.3.4 SCABA method of Revised BCOJ beer analysis method (issued by Public Interest Incorporated Foundation Brewing Society of Japan, Brewers Association International Technology Committee [Analysis Committee] enlarged and revised edition, 2013).

### (Sparkling Property)

The beer-taste beverage according to the present invention may be non-sparkling, but is preferably sparkling. In this way, it is possible to improve “kire” and refreshing feeling of the beer-taste beverage. When producing sparkling beverage, gas pressure is preferably 1.8 kg/cm² (20° C.) and more preferably 2.0 kg/cm² (20° C.). In this way, it is possible to reliably improve “kire” and refreshing feeling of the beer-taste beverage. Note that, it is preferable to use carbon dioxide as a gas when producing the sparkling beverage. When the gas pressure of the beer-taste beverage produced by fermentation is less than 1.8 kg/cm², it can be increased to at least 1.8 kg/cm² by carbonation or by adding carbon dioxide-containing water. The gas pressure of the beer-taste beverage according to the present invention can be measured by, for example, a method described in section 8.21 Gas pressure of Revised BCOJ beer analysis method (issued by Public Interest Incorporated Foundation Brewing Society of Japan, Brewers Association International Technology Committee [Analysis Committee] enlarged and revised edition, 2013).

The beer-taste beverage according to the present invention can be added with, for example, sweetener, high intensity sweetener, antioxidant, fragrance, acidulant, salts, dietary fiber or colorant (hereinafter, referred to as “additive agent”), which is usually blended into the beverage, to the extent that desired effects of the present invention are not impaired. As the sweetener, it is possible to use, for example, high fructose corn syrup, glucose, galactose, mannose, fructose, lactose, sucrose, maltose, glycogen or starch. As the high intensity sweetener, it is possible to use, for example, neotame, acesulfame potassium, sucralose, saccharin, sodium saccharin, disodium glycyrrhizinate, cyclamate, dulcin, stevia, glycyrrhizin, thaumatin, monellin, aspartame or alitame. As the antioxidant, it is possible to use, for example, vitamin C, vitamin E or polyphenols. As the acidulant, it is possible to use, for example, adipic acid, citric acid, trisodium citrate, glucono-δ-lactone, gluconic acid, potassium gluconate, sodium gluconate, succinic acid, monosodium succinate, disodium succinate, sodium acetate, DL-tartaric acid, L-tartaric acid, DL-sodium tartrate, L-sodium tartrate, carbon dioxide, lactic acid, sodium lactate, glacial acetic acid, fumaric acid, monosodium fumarate, DL-malic acid, DL-sodium malate or phosphoric acid. As the salts, it is possible to use, for example, sodium chloride, acidic potassium phosphate, acidic calcium phosphate, ammonium phosphate, magnesium sulfate, calcium sulfate, potassium metabisulfite, calcium chloride, magnesium chloride, potassium nitrate or ammonium sulfate. As the dietary fiber, it is possible to use, for example, indigestible dextrin, pectin, polydextrose or guar gum hydrolysate. As the colorant, it is possible to use, for example, caramel pigment, anthocyanin, gardenia pigment, fruit juice dyes, vegetable dyes or synthetic dyes. Note that, as the additive agents described above, it is possible to use those which are generally commercially available.

### (Packaged Beer-Taste Beverage)

The beer-taste beverage according to the present invention can be provided in various containers. By filling the beer-taste beverage in various containers, it is possible to suitably prevent quality deterioration due to long term storage. Note that, the container only has to be a hermetically sealable one, and it is possible to use so-called can containers or barrel containers made of metal (aluminum, steel or the like). Further, it is also possible to use glass containers, PET bottle containers, paper containers, pouch containers or the like. Volume of the container is not limited in particular, and it is possible to use any one that is currently available. Note that, the container made of metal is preferably used in view of completely blocking gas, water and light and maintaining stable quality for long periods at ambient temperature.

As described above, the beer-taste beverage according to the present invention is excellent in “umami”, refreshing feeling and “kire”, since the use ratio of malt is at least 50%, the alcohol content is at least 4%, the bitterness value is at least 10, and the total polyphenol beverage is at most 140 ppm.

### [Method for Producing Beer-Taste Beverage]

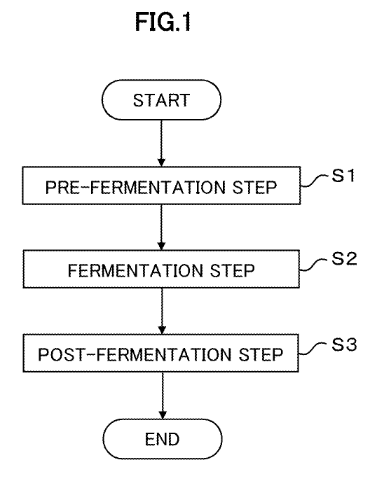

Next, the method for producing the beer-taste beverage according to the present invention will be described. As shown in FIG. 1, the method for producing the beer-taste beverage according to the present invention includes a pre-fermentation step S1, a fermentation step S2 and a post-fermentation step S3. Note that, the above-described additive agent can be added in any step of these.

### (Pre-Fermentation Step S1)

The pre-fermentation step S1 is a step of preparing the pre-fermentation liquid containing the malt. The pre-fermentation liquid prepared in the pre-fermentation step S1 is not particularly limited as long as it is a solution containing the malt and the raw materials other than the malt, which are the nitrogen source and carbon source assimilable by yeast. The nitrogen source and carbon source is not particularly limited as long as it is assimilable by yeast. The nitrogen source assimilable by yeast is, for example, at least one of amino acids and peptides, which are contained in the malt and the raw materials other than the malt. The carbon source assimilable by yeast is, for example, sugars which are contained in the malt and the raw materials other than the malt. Since these raw materials have been already described in detail, the description is omitted. Further, when adding the hop effective to increase the bitterness value to at least the predetermined value, it is preferable to add the hop to the pre-fermentation liquid in this step.

When the pre-fermentation liquid contains the malt and the raw materials other than the malt, it is preferable to perform a step (so-called saccharification step) of decomposing protein and/or polysaccharides contained in these by an enzyme in the pre-fermentation liquid. As such an enzyme, there is, for example, protease and/or amylase. As these enzymes, the enzymes contained in the malt may be used, and the enzymes previously refined may be externally added instead of or in addition to these enzymes.

The pre-fermentation liquid is preferably filtered and is more preferably boiled before fermentation by the yeast in the succeeding fermentation step S2. By filtering the pre-fermentation liquid, it is possible to eliminate contaminants, and thereby providing the beer-taste beverage having higher quality. Further, by boiling the pre-fermentation liquid, it is possible to sterilize this into a sterile state, and thereby appropriately performing the alcohol fermentation in the fermentation step S2.

### (Fermentation Step S2)

The fermentation step S2 is a step of performing the alcohol fermentation by adding the yeast to the pre-fermentation liquid. In the present invention, for example, at first the fermentation liquid is prepared by adding the yeast to the pre-fermentation liquid in a sterile state, which is previously prepared in a predetermined range of temperature (for example, a range of 0 to 40° C.).

The number of the yeast in the fermentation liquid at the start of the fermentation can be appropriately adjusted, for example, in a range of 1×10² to 3×10⁹ cells/mL, and preferably in a range of 1×10⁶ to 3×10⁹ cells/mL.

Then, the fermentation is performed by maintaining this fermentation liquid at a predetermined temperature for a predetermined time. Temperature of the fermentation can be appropriately adjusted, for example, in a range of 0 to 40° C. and preferably in a range of 5 to 25° C.

In the fermentation step S2, aging may be further performed. The aging is performed by further maintaining the fermentation liquid after the above-described fermentation at a predetermined temperature for a predetermined time. By this aging, it is possible to remove turbidity by precipitating insoluble matter in the fermentation liquid, and to improve flavor.

Thus, in the fermentation step S2, it is possible to obtain post-fermentation liquid containing flavor components, taste components and ethanol (alcohol), which are produced by the yeast. Concentration of ethanol (alcohol content) contained in the post-fermentation liquid can be, for example, 1 to 20% by appropriately adjusting fermentation condition, for example, by shortening fermentation time or by lowering fermentation temperature.

### (Post-Fermentation Step S3)

The post-fermentation step S3 is a step of finally obtaining the beer-taste beverage by subjecting the post-fermentation liquid to a predetermined process. As the post-fermentation step S3, for example, there is filtration (so-called primary filtration) of the post-fermentation liquid obtained by the fermentation step S2. By this primary filtration, it is possible to remove insoluble solid content and yeast from the post-fermentation liquid. Further, in the post-fermentation step S3, microfiltration (so-called secondary filtration) of the post-fermentation liquid may be further performed. By the secondary filtration, it is possible to remove bacteria and remaining yeast. In the present invention, it is possible to perform sterilization by heat-treating the post-fermentation liquid instead of the microfiltration, however, it is preferred that such a heat treatment is not performed in view of preferences of the drinkers, thermal efficiency during production, and the like. The primary filtration, the secondary filtration and the heat treatment in the post-fermentation step S3 can be performed in general facilities used during production of the beer-taste beverage.

Here, in the post-fermentation step S3 of the present invention, the fermentation liquid obtained in the fermentation step S2 is treated (filtered) with polyvinylpolypyrrolidone (PVPP). In this way, by treating the fermentation liquid with PVPP, it is possible to reduce the total polyphenol in the beer-taste beverage, which is the final product, to 140 ppm or less. Condition of PVPP treatment is not particularly limited as long as the total polyphenol in the beer-taste beverage can be 140 ppm or less. The PVPP treatment can be performed in at least one of the primary filtration and the secondary filtration.

Further, the method of reducing the total polyphenol includes, for example, use of the hop extract. By containing the hop extract as the bittering agent, and preferably by setting the ratio of the hop extract to the bittering agent to 15 to 100%, it is possible to increase the bitterness value without impairing “umami” while suppressing the total polyphenol. In the present invention, any one or combination of the PVPP treatment and the use of the hop extract may be performed. Note that, in the present invention, it is sufficient that the total polyphenol in the beer-taste beverage can be 140 ppm or less, and the present invention is not limited to these methods.

In order to increase the alcohol content of the post-fermentation liquid, it is preferable to add the alcohol, that is, the spirits or the like, in the post-fermentation step S3. For example, when the alcohol content is less than 4%, it is possible to increase the alcohol content to at least 4% by adding the spirits or the like as described above. Further, when the alcohol content is high, it is possible to reduce the alcohol content by appropriately diluting the post-fermentation liquid. Further, when the produced beer-taste beverage is non-sparkling, or the sparkling property is not sufficient, in order to impart sufficient sparkling property to this, the gas pressure can be increased to a desired pressure by carbonation or by adding carbon-dioxide containing water in the post-fermentation step S3. Furthermore, the post-fermentation step S3 includes a step of filling the container with the final product.

The beer-taste beverage according to the present invention can be produced without going through the fermentation step S2. For example, the beer-taste beverage can be also produced by using the wort having a malt use ratio of at least 50%, by adding the spirits or the like so that the alcohol content is at least 4%, and by reducing the total polyphenol to 140 ppm or less by PVPP treatment of a solution, which is obtained by adding the hop, the hop extract or the like as the bittering agent so that the bitterness value is at least 10.

As described above, with the method for producing the beer-taste beverage according to the present invention, it is possible to produce the beer-taste beverage excellent in “umami”, refreshing feeling and “kire”, since it is produced so that the use ratio of malt is at least 50%, the alcohol content is at least 4%, the bitterness value is at least 10, and the total polyphenol is 140 ppm or less.

### [Method for Improving Taste of Beer-Taste Beverage]

Next, the method for improving the taste of the beer-taste beverage according to the present invention will be described. In the method for improving the taste of the beer-taste beverage according to the present invention, the beer-taste beverage is prepared so that the use ratio of malt is at least a predetermined value, the alcohol content is at least a predetermined value, the bitterness value is at least a predetermined value, and the total polyphenol is a predetermined value or less.

In the method for improving the taste of the beer-taste beverage according to the present invention, the beer-taste beverage which is the final product is prepared so that the use ratio of malt is at least 50%. Note that, the use ratio of malt is preferably at least 66.7%, however, it may be 100%.

In the method for improving the taste of the beer-taste beverage according to the present invention, the beer-taste beverage which is the final product is prepared so that the alcohol content is at least 4%. Note that, the alcohol content is preferably at least 5%. Further, the alcohol content is preferably at most 8%, and more preferably at most 7%.

In the method for improving the taste of the beer-taste beverage according to the present invention, the beer-taste beverage which is the final product is prepared so that the bitterness value is at least 10. Note that, the bitterness value is preferably at least 15 and at most 50.

Then, in the method for improving the taste of the beer-taste beverage according to the present invention, the beer-taste beverage which is the final product is prepared so that the total polyphenol is 140 ppm or less. Note that, the total polyphenol is preferably at most 130 ppm, more preferably at most 120 ppm, further preferably at most 110 ppm, and further more preferably at most 100 ppm. Further, the total polyphenol is preferably at least 50 ppm.

As described above, with the method for improving the taste of the beer-taste beverage according to the present invention, it is possible to produce the beer-taste beverage excellent in “umami”, refreshing feeling and “kire”, since it is produced so that the use ratio of malt is at least 50%, the alcohol content is at least 4%, the bitterness value is at least 10, and the total polyphenol is 140 ppm or less.

Note that, with the beer-taste beverage according to the present invention, the method for producing the same, and the method for improving taste of the same, conditions and characteristics which are not clearly specified may be conventionally known, and they are of course not limited as long as the effects are obtained by the conditions and characteristics.

### Embodiments

Next, the beer-taste beverage according to the present invention, the method for producing the same, and the method for improving taste of the same will be described together with embodiments satisfying requirements of the present invention and comparative examples not satisfying the requirements.

### (Analysis of Commercially Available Beer)

Before describing contents of the present invention, the alcohol content, the bitterness value, the total polyphenol, the total nitrogen, the original wort extract concentration and the gas pressure of commercially available beers (commercial products A, B) are measured. These are measured according to the following methods. The alcohol content is measured by the method described in section 8.3 Alcohol of Revised BCOJ beer analysis method (issued by Public Interest Incorporated Foundation Brewing Society of Japan, Brewers Association International Technology Committee [Analysis Committee] enlarged and revised edition, 2013). The bitterness value is measured by the method described in section 8.15 Bitterness value of Revised BCOJ beer analysis method (issued by Public Interest Incorporated Foundation Brewing Society of Japan, Brewers Association International Technology Committee [Analysis Committee] enlarged and revised edition, 2013). The total polyphenol is measured by the method described in section 8.19 Total polyphenol of Revised BCOJ beer analysis method (issued by Public Interest Incorporated Foundation Brewing Society of Japan, Brewers Association International Technology Committee [Analysis Committee] enlarged and revised edition, 2013). The total nitrogen is measured by the method described in section 8.9 Total nitrogen of Revised BCOJ beer analysis method (issued by Public Interest Incorporated Foundation Brewing Society of Japan, Brewers Association International Technology Committee [Analysis Committee] enlarged and revised edition, 2013). The original wort extract concentration is measured by the method described in section 8.3.4 SCABA method of Revised BCOJ beer analysis method (issued by Public Interest Incorporated Foundation Brewing Society of Japan, Brewers Association International Technology Committee [Analysis Committee] enlarged and revised edition, 2013). The gas pressure is measured by the method described in section 8.21 Gas pressure of Revised BCOJ beer analysis method (issued by Public Interest Incorporated Foundation Brewing Society of Japan, Brewers Association International Technology Committee [Analysis Committee] enlarged and revised edition, 2013). Results of these measurements are shown in Table 1.

TABLE 1

| | Commercial | Commercial |
|---|---|---|
| | product A | product B |
| Alcohol content (%) | 5.11 | 4.96 |
| Bitterness value | 19.1 | 22.3 |
| Total polyphenol (ppm) | 151.0 | 160.0 |
| Total nitrogen (g/100 mL) | 0.05 | 0.05 |
| Original wort extract concentration (%) | 11.15 | 11.00 |
| Gas pressure (20° C.) (kg/cm²) | 2.3 | 2.2 |

### (Production of Fermentation Liquid for Sample Preparation)

In order to prepare evaluation samples, fermentation liquids A, B for sample preparation are produced as follows. First, all (100%) of the malt for sample preparation is the barley malt. The use ratio of malt in the raw materials (excluding bittering agent and water) of the fermentation liquid A for sample preparation is 70% as shown in Table 2. Note that, all (100%) of the barley malt is the LOX-less malt. The hop extract 100% is used as the bittering agent. Using these raw materials, the pre-fermentation liquid is produced at a temperature condition and the like, which are normally applied during production of beer. Next, the fermentation liquid is produced by alcohol fermentation of the pre-fermentation liquid at a temperature condition and the like, which are normally applied during the production of beer (an aging period of at least 20 days). Then, the fermentation liquid A for sample preparation shown in Table 2 is produced by treating (filtering) the fermentation liquid with PVPP.

The fermentation liquid B for sample preparation is produced in the same conditions as the fermentation liquid A for sample preparation except that the hop extract 10% and the hop pellets 90% are used as the bittering agent, and the PVPP treatment is not performed. The alcohol content, the bitterness value, the total polyphenol, the total nitrogen, the original wort extract concentration and the gas pressure of the produced fermentation liquids A, B for sample preparation are measured by the same method as described in the analysis of the commercially available beers. Contents of the fermentation liquids A, B for sample preparation are shown in Table 2. Note that, as shown in Tables 1 and 2, it is confirmed that the total polyphenol of the fermentation liquid B for sample preparation is equivalent to that of the commercially available beers (commercial products A, B).

TABLE 2

| | Fermentation | Fermentation |
|---|---|---|
| | liquid A | liquid B |
| | for sample | for sample |
| | preparation | preparation |
| Use ratio of malt in raw materials (%) | 70 | 70 |
| Alcohol content (%) | 5.52 | 5.56 |
| Bitterness value | 20.6 | 20.8 |
| Total polyphenol (ppm) | 100 | 150 |
| Total nitrogen (g/100 mL) | 0.05 | 0.05 |
| Hop extract (%) | 100 | 10 |
| Original wort extract concentration (%) | 12.24 | 12.73 |
| Gas pressure (20° C.) (kg/cm²) | 2.21 | 2.38 |

### (Preparation of Evaluation Sample)

By mixing the fermentation liquids A, B for sample preparation, which are produced as described above, in various proportions, or without mixing, Sample 1 of total polyphenol 100 ppm, Sample 2 of total polyphenol 110 ppm, Sample 3 of total polyphenol 120 ppm, Sample 4 of total polyphenol 130 ppm, Sample 5 of total polyphenol 140 ppm, and Sample 6 of total polyphenol 150 ppm are produced. Note that, in any of Samples 1 to 6, the use ratio of malt is at least 50%, the alcohol content is at least 4%, and the bitterness value is at least 10.

Trained specialist panel of seven members taste Samples 1 to 6, and independently score points for “umami”, refreshing feeling, “kire” and comprehensive evaluation on a scale of 1 to 5 according to the following evaluation criteria, to calculate their average values. These evaluation results are shown in FIG. 3 along with the total polyphenol of each sample.

### (“Umami” (Taste))

5 points: “umami” is extremely strong

4 points: “umami” is intermediate between 3 points and 5 points

3 points: “umami” is felt

2 points: “umami” is intermediate between 1 point and 3 points

1 point: “umami” is not felt

### (Refreshing Feeling)

5 points: much more refreshing feeling is obtained as compared to when drinking commercially available beer

4 points: refreshing feeling is intermediate between 3 points and 5 points

3 points: refreshing feeling is the same as when drinking commercially available beer

2 points: refreshing feeling is intermediate between 1 point and 3 points

1 point: no refreshing feeling is obtained as compared to when drinking commercially available beer

### (“Kire” (Sharpness))

5 points: after feeling “umami”, time until “umami” disappears is very short as compared to when drinking commercially available beer

4 points: “kire” is intermediate between 3 points and 5 points

3 points: after feeling “umami”, the time until “umami” disappears is the same as when drinking commercially available beer

2 points: “kire” is intermediate between 1 point and 3 points

1 point: after feeling “umami”, the time until “umami” disappears is very long as compared to when drinking commercially available beer

### (Comprehensive Evaluation)

5 points: balance as the beer-taste beverage is much better than commercially available beer

4 points: balance as the beer-taste beverage is intermediate between 3 points and 5 points

3 points: balance as the beer-taste beverage is the same as commercially available beer

2 points: balance as the beer-taste beverage is intermediate between 1 point and 3 points

1 point: balance as the beer-taste beverage is much worse than commercially available beer

TABLE 3

| | Sample 1 | Sample 2 | Sample 3 | Sample 4 | Sample 5 | Sample 6 |
|---|---|---|---|---|---|---|
| Total polyphenol (ppm) | 100 | 110 | 120 | 130 | 140 | 150 |
| Refreshing feeling | 4.9 | 4.6 | 4.0 | 3.9 | 3.3 | 3.0 |
| “Kire” (sharpness) | 4.9 | 4.7 | 4.0 | 4.0 | 3.3 | 3.0 |
| “Umami” (taste) | 4.6 | 4.7 | 4.9 | 4.9 | 4.7 | 4.7 |
| Comprehensive evaluation | 4.6 | 4.6 | 4.0 | 3.9 | 3.1 | 3.0 |

As shown in Table 3, since Samples 1 to 5 satisfy the requirements of the present invention, it is confirmed that it is possible to improve refreshing feeling and “kire” without impairing “umami” as compared to Sample 6 which does not satisfy the requirements of the present invention. That is, from the results of Samples 1 to 5, it is confirmed that it is possible to provide the beer-taste beverage excellent in “umami”, refreshing feeling and “kire”. In particular, it is confirmed that Samples 1 to 3 are excellent in “umami”, refreshing feeling and “kire”, and Sample 1 is most excellent in “umami”, refreshing feeling and “kire” among these.

### REFERENCE SIGNS LIST

S1: pre-fermentation step
S2: fermentation step
S3: post-fermentation step

1. A beer-taste beverage, wherein use ratio of malt is at least 50%, alcohol content is at least 4%, bitterness value is at least 10, and total polyphenol is 140 ppm or less.

2. The beer-taste beverage according to claim 1, wherein the malt is barley malt.

3. The beer-taste beverage according to claim 2, wherein the barley malt contains LOX-less malt.

4. The beer-taste beverage according to claim 1, wherein total nitrogen is at least 40 mg/100 mL.

5. The beer-taste beverage according to any one of claim 1, wherein original wort extract concentration is at least 10%.

6. The beer-taste beverage according to any one of claim 1, containing hop extract as a bittering agent, wherein a use ratio of the hop extract to the bittering agent is 15% to 100%.

7. The beer-taste beverage according to any one of claim 1, wherein gas pressure is at least 1.8 kg/cm².

8. A method for producing a beer-taste beverage, in which use ratio of malt is at least 50%, alcohol content is at least 4%, bitterness value is at least 10, and total polyphenol is 140 ppm or less, the method comprising:
a fermentation step of obtaining fermentation liquid by alcohol fermentation; and
a post-fermentation step after alcohol fermentation,
wherein in the post-fermentation step, fermentation liquid obtained in the fermentation step is treated with polyvinylpolypyrrolidone, to reduce the total polyphenol to 140 ppm or less.

9. The method for producing the beer-taste beverage according to claim 8,
wherein heat treatment is not performed in the post-fermentation step.

10. A method for improving taste of a beer-taste beverage,
wherein the taste of the beer-taste beverage is improved so that use ratio of malt is at least 50%, alcohol content is at least 4%, bitterness value is at least 10, and total polyphenol is 140 ppm or less.
